(19) United States
(12) Patent Application Publication
(10) Pub. No.: US 2010/0083930 A1
(43) Pub. Date: Apr. 8, 2010

(54) Lower Valve Cover and Intake Manifold Assembly

(75) Inventors: Matthew J. Clarke, Grayslake, IL (US); Paul Gottemoller, Palos Park, IL (US); Jack Morais, Arlington Heights, IL (US); Michael Pyzik, Orland Park, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company , LLC, Warrenville, IL (US)

(21) Appl. No.: 12/247,036

(22) Filed: Oct. 7, 2008

(51) Int. Cl. F02B 77/02

(52) U.S. Cl. 123/195 C; 123/568.12

(57) ABSTRACT

A lower valve cover and intake manifold assembly (12) for an engine (10) having a cylinder head (14) and a valve cover (16) includes an intake manifold portion (20) having a first surface (36) attached to the cylinder head (14). The assembly (12) also includes a valve cover portion (18) extending from the intake manifold portion (20) and having a first surface (46) attached to the cylinder head (14) and a second surface (48) attached to the valve cover (16). The assembly (12) is disposed on the engine (10) between the cylinder head (14) and the valve cover (16).

### FIELD OF THE INVENTION

This invention relates to internal combustion engines. More particularly, this invention relates to a lower valve cover and an intake manifold of an internal combustion engine having an exhaust gas recirculation (EGR) system.

### BACKGROUND OF THE INVENTION

Most internal combustion engines have some type of emission control device and system. One common type of control system is an exhaust gas recirculation (EGR) system that recirculates exhaust gas from an exhaust system to an intake system of the engine. A high pressure EGR system typically recirculates exhaust gas from upstream of a turbine to downstream of a compressor. Other EGR systems recirculate gas at a low pressure, and are called low-pressure systems. An engine having a high-pressure EGR system has a junction in the air intake system where the EGR gas and the intake air mix to form a mixture. This mixture of exhaust gas and intake air is consumed during engine operation.

A drawback of EGR systems is the amount of space they require. The vehicle packaging becomes larger when EGR systems are incorporated. In addition to having a larger packaging, EGR systems also have an increased amount of parts, more complex designs, and increased noise, vibration and harshness (NVH) than an engine without an EGR system. Further, increased amounts of parts and more complex designs typically translates to increased costs to produce the vehicle.

### SUMMARY OF THE INVENTION

A lower valve cover and intake manifold assembly for an engine having a cylinder head and a valve cover includes an intake manifold portion having a first surface attached to the cylinder head. The assembly also includes a valve cover portion extending from the intake manifold portion and having a first surface attached to the cylinder head and a second surface attached to the valve cover. The assembly is disposed on the engine between the cylinder head and the valve cover.

### BRIEF DESCRIPTION OF THE DRAWINGS

FIG. 1 is a block diagram of a prior art, exemplary internal combustion engine with an exhaust gas recirculation (EGR) system.

FIG. 2 is a front perspective view of an engine having an lower valve cover and intake manifold assembly in accordance with the invention.

FIG. 3 is a partial section view of the engine having the lower valve cover and intake manifold assembly in accordance with the invention.

FIG. 4 is a top view of the engine having the lower valve cover and intake manifold assembly in accordance with the invention.

FIG. 5 is a front perspective view of the lower valve cover and intake manifold assembly in accordance with the invention.

### DESCRIPTION OF A PREFERRED EMBODIMENT

The following describes an apparatus for an internal combustion engine having an exhaust gas recirculation (EGR) system associated therewith. The EGR system described herein mixes exhaust gas with intake air to yield a mixture. The mixture is consumed by the engine by combustion within a plurality of cylinders.

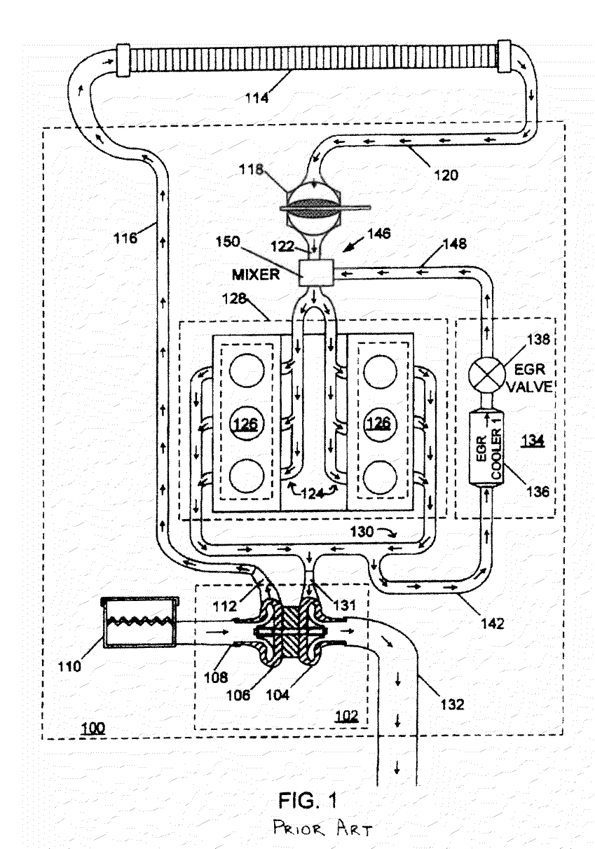

A block diagram of an exemplary, prior art engine 100 having an EGR system, as installed in a vehicle, is shown in FIG. 1. The engine 100 includes a turbocharger 102 having a turbine 104 and a compressor 106. The compressor 106 has an air inlet 108 connected to an air cleaner or filter 110, and a charge air outlet 112 connected to a charge air cooler (CAC) 114 through CAC-hot passage 116. The CAC 114 has an outlet connected to an intake throttle valve (ITH) 118 through a CAC-cold passage 120. The ITH 118 is connected to an intake air conduit 122 that fluidly communicates with an intake system of the engine 100, the intake system generally shown as 124. Branches of the intake system 124 are fluidly connected to each of a plurality of cylinders 126 that are included in a crankcase 128 of the engine 100.

Each of the plurality of cylinders 126 of the engine is connected to an exhaust system, generally shown as 130. The exhaust system 130 of the engine 100 is connected to an inlet 131 of the turbine 104. An exhaust pipe 132 is connected to an outlet of the turbine 104. Other components, such as a muffler, catalyst, particulate filter, and so forth, may be connected to the exhaust pipe 132 and are not shown for the sake of simplicity.

The engine 100 has an EGR system, generally shown as 134. The EGR system 134 includes an EGR cooler 136 and an EGR valve 138 connected in a series configuration with each other for passage of exhaust gas therethrough. The EGR cooler 136 fluidly communicates with the exhaust system 130 through an EGR gas supply passage 142. The EGR valve 138 is disposed in line with a cooled-EGR gas passage 148 that is in fluid communication with a junction 146 that is part of the intake air conduit 122. A mixer 150 is located at the junction 146 and fluidly communicates with and connects the cooled-EGR gas passage 148 with the intake air conduit 122.

During operation of the engine 100, air is filtered in the filter 110 and enters the compressor 106 through the inlet 108 where it is compressed. Compressed, or charged, air exits the compressor 106 through the outlet 112 and is cooled in the CAC 114 before passing through the ITH 118. Air from the ITH 118 is mixed with exhaust gas from the cooled-EGR gas passage 148 at the junction 146 through the mixer 150 to yield a mixture. The mixture passes to the intake system 124 by continuing through the intake pipe 122 after the mixer 150 and enters the cylinders 126. While in the cylinders 126, the mixture is additionally mixed with fuel and combusts yielding useful work to the engine 100, heat, and exhaust gas. The exhaust gas from each cylinder 126 following combustion is collected in the exhaust system 130 and routed to the turbine 104. Exhaust gas passing through the turbine 104 yields work that is consumed by the compressor 106.

A portion of the exhaust gas in the exhaust system 130 bypasses the turbine 104 and enters the EGR gas supply passage 142. Exhaust gas entering the passage 142 is exhaust gas that will be recirculated into the intake system 124. The recirculated exhaust gas is cooled in the EGR cooler 136, its amount is metered by the EGR valve 138, and then the gas is routed to the junction 146 for mixing with the charge air exiting the ITH 118 in the mixer 150.

It should be appreciated that the engine 100 and the EGR system 134 provides an overview of how an EGR system works. One problem associated with engines having an EGR system, such as engine 100 having an EGR system 134, is amount of additional components required, and the amount of space that the components take up in the vehicle packaging.

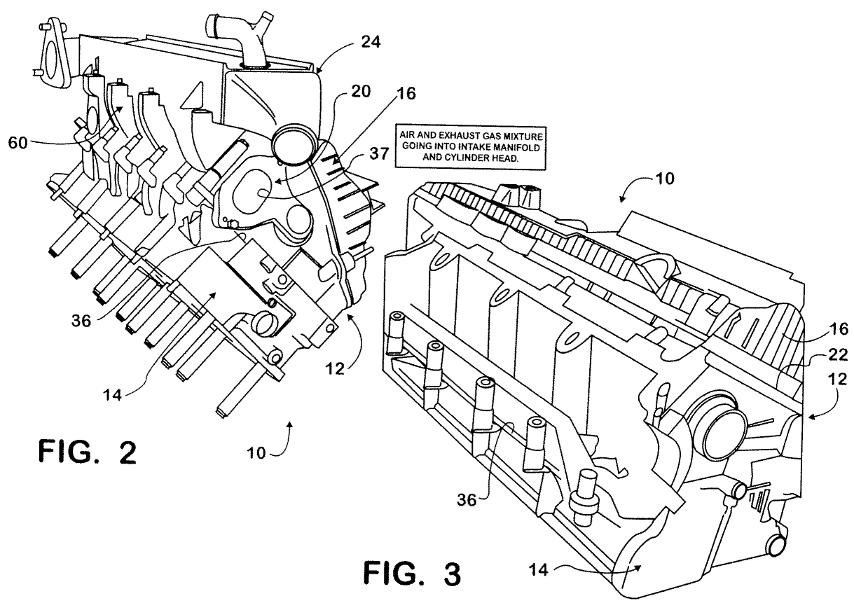

Referring now to FIG. 2, an engine is indicated generally at 10 and includes a lower valve cover and intake manifold assembly, which is indicated generally at 12. For ease of reference, the lower valve cover and intake manifold assembly 12 will herein be referred to as the “lower assembly 12”. The lower assembly 12 is disposed between a cylinder head 14 and a valve cover 16 of the engine 10.

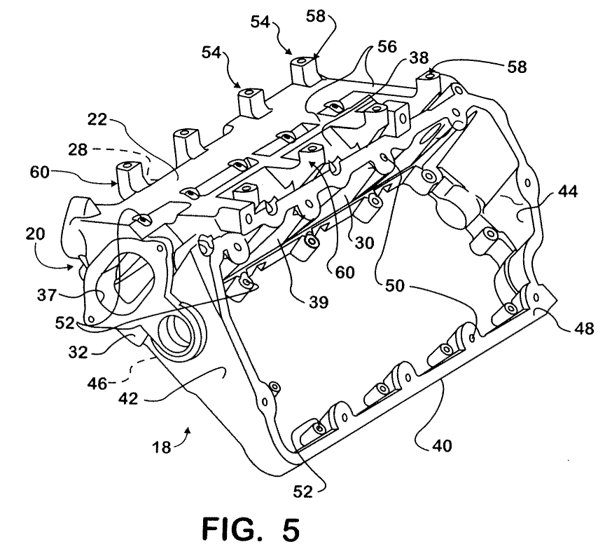

Referring to FIG. 5, the lower assembly 12 has a valve cover portion, indicated generally at 18, that is generally rectangular-ring shaped to extend from the perimeter of the cylinder head 14. The lower assembly 12 also has an intake manifold portion, indicated generally at 20, to receive the air and exhaust gas mixture going into the cylinder head 14. Further, the lower assembly 12 has a support portion, indicated generally at 22, for supporting an EGR cooler 24 (see FIG. 2). Advantageously, the intake manifold portion 20, the valve cover portion 18 and the support portion 22 are integrally formed together to form the lower assembly 12. Further, the lower assembly 12 is advantageously integrally formed of aluminium, however a separate construction and other materials are contemplated.

Referring now to FIGS. 3-5, the intake manifold portion 20 supplies the fuel and exhaust air mixture to the cylinders 26 located in the cylinder head 14. The intake manifold portion 20 is generally box or compartment shaped and has a first wall 28 and a second wall 30. A third wall 32 and a fourth wall 34 of the intake manifold portion 20 are generally perpendicular to the first wall 28 and the second wall 30 of the intake manifold portion.

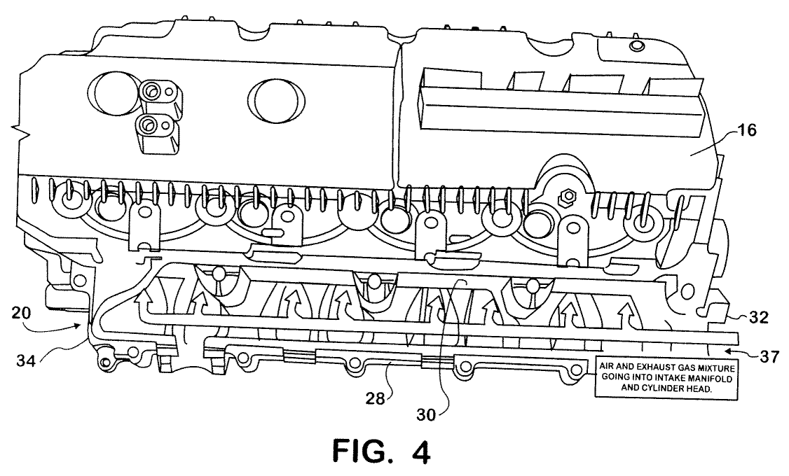

The first wall 28, the second wall 30, the third wall 32 and the fourth wall 34 define a surface 36 that is configured to engage the cylinder head 14 (FIG. 3). Opposite the surface is a fifth wall 38 that extends from the first wall 28 to the second wall 30, and from the third wall 32 to the fourth wall 34 to form a compartment or manifold. An inlet 37 is disposed on the third wall 32 of the intake manifold portion 20 and is configured for allowing the air and exhaust gas mixture into the intake manifold portion. Referring to FIGS. 3 and 4, once the mixture is in the intake manifold portion 20, the mixture can enter the cylinder head 14 where the mixture is additionally mixed with fuel and combusts, yielding useful work to the engine 10, heat, and exhaust gas.

The valve cover portion 18 of the lower assembly 12 has four walls to the generally rectangular ring shape. A first wall 39 has a first height. It is contemplated that the second wall 30 of the intake manifold portion 20 is common to the first wall 39 of the valve cover portion 18. A second wall 40 is located opposite the first wall 39 and has a second height. Extending between the first wall 39 and the second wall 40 are a third wall 42 and a fourth wall 44 having decreasing height from the first wall to the second wall.

A first surface 46 and a second surface 48 are defined by the four walls 39, 40, 42, 44, with the first surface configured to engage the cylinder head 14, and the second surface configured to engage valve cover 16. A plurality of fastener holes 50 are disposed around the valve cover portion 18 to fasten the valve cover portion to the valve cover 16 and the cylinder head 14. When assembled, the valve cover portion 18 of the lower assembly 12 becomes an extension of the valve cover 16. An exhaust gas outlet 52 is disposed in the third wall 42 of the valve cover portion 18 for allowing exhaust gases to exit the engine 10.

As seen in FIG. 5, together the third walls 32, 42 of the intake manifold portion 20 and the valve cover portion 18 are together generally triangular or wedge-shaped. Further, referring to FIG. 2, the manifold portion 20 and the valve cover portion 18 are attached to the cylinder head 14 and to the valve cover 16 at a plurality of locations with fasteners 52.

Referring back to FIG. 5, the support portion 22 of the lower assembly 12 includes at least one, and advantageously a plurality of spaced cradle structures 54 extending along a length of the intake manifold portion 20, although other configurations are contemplated. Advantageously, the cradle structure 54 includes a central rib 56 and two arms 58 extending generally perpendicular to the rib on each wall of the rib, however other configurations are contemplated. The cradle structures 54 are configured to cradle the housing of the EGR cooler 24 at a bottom surface and at two wall surfaces (FIG. 2). The cradle structures 54 are advantageously buttressed with supports 60 extending from the first wall 28 and fifth wall 38 of the intake manifold portion 20.

The lower assembly 12 combines an intake manifold, a valve cover and an EGR cooler support into a single, less complex assembly. The lower assembly 12 decreases the numbers of parts, and improves the noise, vibration and harshness (NVH) as compared to a conventional engine with EGR system. Further, the lower assembly 12 yields a smaller packaging, and an overall lower EGR system mounting on the engine. A lower mounting on the engine allows for any air that could potentially be trapped in the cooler 24 to vent to the de-gas bottle on the engine. A lower mounting also tends to improve the structural rigidity of the cooler 24.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A lower valve cover and intake manifold assembly for an engine having a cylinder head and a valve cover, comprising:
an intake manifold portion having a first surface attached to the cylinder head;
a valve cover portion extending from the intake manifold portion and having a first surface attached to the cylinder head and a second surface attached to the valve cover;
wherein the assembly is disposed on the engine between the cylinder head and the valve cover.

2. The assembly of claim 1 wherein the intake manifold portion and the valve cover portion are integrally formed.

3. The assembly of claim 1 wherein the valve cover portion is generally rectangular ring shaped and further comprises a first wall, a second wall generally parallel to the first wall, and a third wall and a fourth wall extending between the first wall and the second wall.

4. The assembly of claim 3 wherein the first wall has a first height, and the second wall has a second height, wherein the third wall and the fourth wall have decreasing height from the first wall to the second wall.

5. The assembly of claim 3 further comprising an exhaust gas outlet disposed in the third wall for allowing exhaust gases to exit the engine.

6. The assembly of claim 1 wherein the intake manifold portion has a first wall and a second wall parallel to the first wall, and a third wall and a fourth wall are generally perpendicular to the first wall and the second wall.

7. The assembly of claim 6 wherein the first wall, second wall, third wall and fourth walls define the first surface that is configured to engage the cylinder head, and opposite the first surface is a fifth wall that extends from the first wall to the second wall, and from the third wall to the fourth wall.

8. The assembly of claim 6 further comprising an inlet disposed on the third wall of the intake manifold portion and configured for allowing the air and exhaust gas mixture into the intake manifold portion.

9. The assembly of claim 1 further comprising a support portion having at least one cradle structure.

10. The assembly of claim 9 wherein the cradle structure extends along a length of the intake manifold portion.

11. The assembly of claim 9 wherein the cradle structure further comprises a central rib and two arms extending generally perpendicular to the rib, and is configured to cradle a housing of an EGR cooler.

12. The assembly of claim 9 wherein the support portion comprises a plurality of cradle structures spaced along a length of the intake manifold portion.

13. A lower valve cover and intake manifold assembly for an engine having a cylinder head and a valve cover, comprising:
an intake manifold portion attached to the cylinder head;
a valve cover portion extending from the intake manifold portion and attached to the cylinder head and the valve cover; and
a support portion extending from the intake manifold portion and having at least one cradle structure configured for receiving an EGR cooler.

14. The assembly of claim 13 wherein the intake manifold portion, the valve cover portion and the support portion are integrally formed.

15. The assembly of claim 13 wherein the support portion further comprises at least one cradle structure extending along a length of the intake manifold.

16. The assembly of claim 15 wherein the cradle structure further comprises a central rib and two arms extending generally perpendicular to the rib.

17. The assembly of claim 13 wherein the valve cover portion is generally rectangular ring shaped and further comprises a first wall, a second wall generally parallel to the first wall, and a third wall and a fourth wall extending between the first wall and the second wall.

18. The assembly of claim 17 further comprising an exhaust gas outlet disposed in the third wall for allowing exhaust gases to exit the engine.

19. The assembly of claim 13 wherein the intake manifold portion has a first wall and a second wall parallel to the first wall, and a third wall and a fourth wall generally perpendicular to the first wall and the second wall, and wherein an inlet is disposed on the third wall.

20. A lower valve cover and intake manifold assembly for an engine having a cylinder head and a valve cover, comprising:
an intake manifold portion attached to the cylinder head, wherein the intake manifold portion has a first wall and a second wall parallel to the first wall, and a third wall and a fourth wall are generally perpendicular to the first wall and the second wall;
a valve cover portion extending from the intake manifold portion and attached to the cylinder head and the valve cover, wherein the valve cover portion is generally rectangular ring shaped; and
a support portion extending from the intake manifold portion and having at least one cradle structure configured for receiving an EGR cooler;
wherein the intake manifold portion, the valve cover portion and the support portion are integrally formed.
